(19) United States
(12) Patent Application Publication
(10) Pub. No.: US 2008/0091726 A1
(43) Pub. Date: Apr. 17, 2008

(54) Methods for scheduling and completing reservations within an application and systems thereof

(75) Inventors: David A. Koretz, Rochester, NY (US); Rob Chamberlin, Webster, NY (US); James Simpson, Rochester, NY (US); Stephen Wong, Rochester, NY (US)

Correspondence Address: NIXON PEABODY LLP - PATENT GROUP, 1100 CLINTON SQUARE, ROCHESTER, NY, 14604, US

(73) Assignee: BlueTie, Inc., Pittsford, NY (US)

(21) Appl. No.: 11/581,728

(22) Filed: Oct. 16, 2006

(51) Int. Cl. G06F 17/00

(52) U.S. Cl. 707/104.1

(57) ABSTRACT

A method, computer readable medium, and system for scheduling and completing a reservation includes receiving at least one query for a dynamic event where the query comprises category criteria and date criteria. A dynamic set of one or more options which satisfy the category criteria and the date criteria in the query are identified in real time. Each of the identified dynamic options are entered and displayed in real time.

### FIELD OF THE INVENTION

This invention generally relates to reservation systems and methods thereof and, more particularly, to methods for scheduling and completing reservations in applications and systems thereof.

### BACKGROUND

There are several desktop software applications that have electronic calendars which are designed for a user to store their own personal calendar in electronic form. There also are several networked calendaring systems that enable users to share calendars between users of the system. A few of these systems have limited capabilities to enable sharing beyond users of the system. Further, there are many Web-based calendaring systems that enable users to share their personal calendar more easily over the Web or view pre-formatted content in a calendar overlay, such as a sports team's games.

One of these prior art calendaring systems and methods is disclosed in U.S. Pat. No. 6,369,840 to Barnett et al. (Barnett) which is herein incorporated by reference in its entirety. Basically, Barnett discloses a multi-layered online calendaring and purchasing system and method which allows a user to specify categories of events, to view events belonging to the specified categories from outside sources, and to add selected events from the outside sources to a personal calendar. In Barnett, the user can choose which categories of selected events are to be displayed, in any combination he or she desires.

Although the prior art described above is helpful for some types of calendaring, it is limited in its usefulness to static or nearly-static content that is generated for the one-to-many communication of information to a large population of users. In other words, it works well for groups of events that rarely or never change and that have relatively few total events, and that have broad relevance, such as a schedule for a sporting team or a list of trade shows. The prior art does not work well for reservations of events that involve large amounts of dynamic data, such as air travel, dinner reservations, and train travel, which can rapidly change and need to be filtered by a query to create a useful view.

### SUMMARY

A method for scheduling and completing a reservation in accordance with embodiments of the present invention includes receiving at least one query for a dynamic event where the query comprises category criteria and date criteria. A dynamic set of one or more options which satisfy the category criteria and the date criteria in the query are identified in real time. Each of the identified dynamic options are entered and displayed in real time.

A computer readable medium in accordance with other embodiments of the present invention has stored thereon instructions for scheduling and completing a reservation comprising machine executable code which when executed by at least one processor, causes the processor to perform steps that include receiving at least one query for a dynamic event where the query comprises category criteria and date criteria. A dynamic set of one or more options which satisfy the category criteria and the date criteria in the query are identified in real time. Each of the identified dynamic options are entered and displayed in real time.

A reservation system in accordance with other embodiments of the present invention includes a communication system, a search system, a display processing system, and a transaction system. The communication system receives at least one query for a dynamic event and query comprises category criteria and date criteria. The search system identifies a dynamic set of one or more options in real time which satisfy at least the category criteria and the date criteria in the query. The display processing system enters and displays in real time each of the identified dynamic options.

The present invention provides a number of advantages including providing an effective method for users of a Web-based or client-server software application to complete real-time reservations, such as ticketing, without leaving the application. The present invention also provides the user with the ability to search a large number of options in real-time to find the event that matches the user-driven criteria. Additionally, the present invention lets the user filter, sort, and display search results based on user input criteria, such as price, time, location, duration, genre, and cuisine, thus improving the relevancy of the results. Further, the present invention provides the user with a high quality reservation experience and consistent interface without ever requiring the user to leave the application or visit multiple website URLs.

### BRIEF DESCRIPTION OF THE DRAWINGS

FIG. 1 is a block diagram of a system that schedules and completes a reservation within an application in real time in accordance with embodiments of the present invention;

FIG. 2 is a flow chart of a method for scheduling and completing a reservation within an application in real time in accordance with embodiments of the present invention; and

FIGS. 3A-3E are screenshots of an example of scheduling and completing a travel reservation in real time in accordance with embodiments of the present invention.

### DETAILED DESCRIPTION

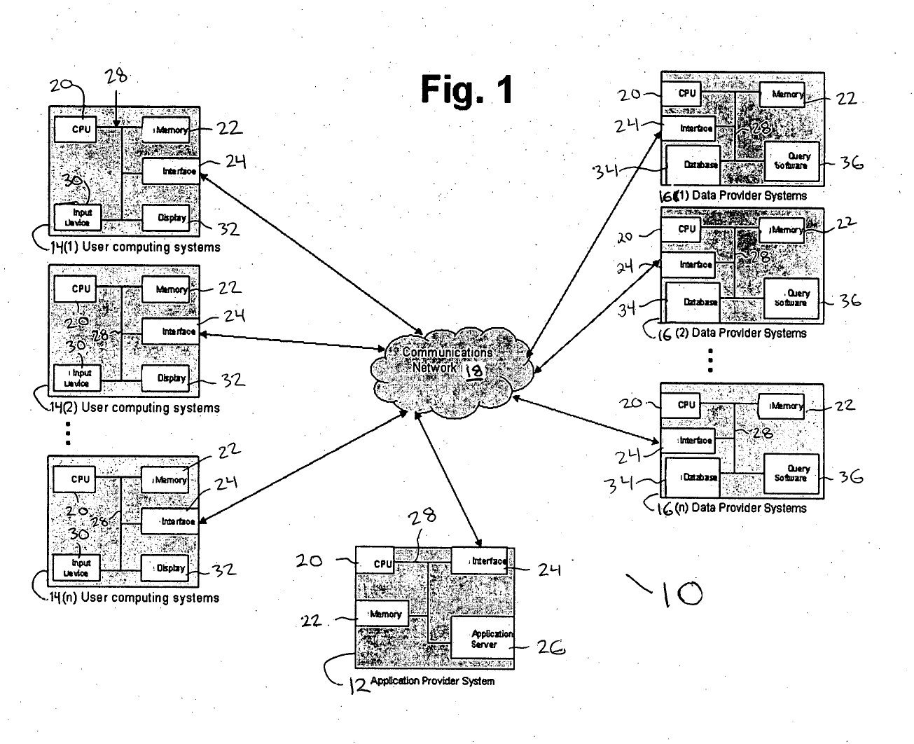

A system 10 that schedules and completes a reservation within an application in real time in accordance with other embodiments of the present invention is illustrated in FIG. 1. The system 10 includes user computing systems 14(1)-14(n), an application provider system 12, data provider systems 16(1)-16(n), and communications system or network 18, although the system 10 can comprise other numbers and types of systems, devices, equipment, components, and/or databases in other configurations. The present invention provides a number of advantages including providing an effective and automatic process for users of a Web-based or client-server software application to complete real-time reservations for events.

Referring more specifically to FIG. 1, the application provider system 12 provides one or more applications to the user computing systems 14(1)-14(n), such as a calendar application or a Web page by way of example only, although other numbers and types of systems which provide other numbers and types of applications can be used. The application provider system 12 includes a central processing unit (CPU) or processor 20, a memory 22, an interface system 24, and an application server 26 which are coupled together by a bus or other link 28, although other numbers and types of systems, devices, equipment, components, and/or databases in other configurations can be used.

The processor 20 in the application provider system 12 executes a program of stored instructions for one or more aspects of the present invention as described herein, including a method for scheduling and completing a reservation within an application in real time. The memory 22 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, flash memory, CD ROM, DVD ROM, or other computer readable medium which is read from and/or written to by a magnetic, optical, or other reading and/or writing system that is coupled to the processor 20, can be used for the memory 22. The interface system 24 in application provider system 12 is used to operatively couple and communicate between the application provider system 12 and the user computing systems 14(1)-14(n) and data provider systems 16(1)-16(n) via communications system 18, although other types and numbers of connections and other configurations and other types of communication systems could be used. In this particular embodiment, the communication system 18 is via TCP/IP over Ethernet and uses industry-standard protocols including SOAP, HTTP, HTTPS, XML, LDAP, UDDI, WSDL, and SNMP, although other types and numbers of communication systems, such as a direct connection, a local area network, a wide area network, modems and phone lines, e-mails, and/or wireless communication technology each having their own communications protocols, could be used. The application server 26 stores and creates the presentation layers for the application or applications and returns the created layer to one or more of the user computing systems 14(1)-14(n), although the results could be transmitted to other systems.

Each of the user computing systems 14(1)-14(n) enables a user to utilize the application or applications from the application provider system 12, such as the calendar application by way of example only, although one or more of the user computing systems 14(1)-14(n) could utilize other applications and could provide a wide variety of other functions for the user. Each of the user computing systems 14(1)-14(n) includes a central processing unit (CPU) or processor 20, a memory 22, an interface system 24, a user input device 30, and a display 32 which are coupled together by a bus or other link 28, although one or more of the user computing systems 14(1)-14(n) can comprise other numbers and types of systems, devices, equipment, components, and/or databases in other configurations.

The processor 20 in each of the user computing systems 14(1)-14(n) executes a program of stored instructions for one or more aspects of the present invention as described and illustrated herein, including scheduling and completing a reservation within an application in real time, although each of the processors 20 in user computing systems 14(1)-14(n) could execute other types of programmed instructions.

The memory 22 in each of the user computing systems 14(1)-14(n) stores these programmed instructions for one or more aspects of the present invention as described herein, including scheduling and completing a reservation within an application in real time, although some or all of the programmed instructions could be stored and/or executed elsewhere. A variety of different types of memory storage devices, such as a random access memory (RAM), flash memory, or a read only memory (ROM) in the system or a floppy disk, hard disk, CD ROM, DVD ROM, or other computer readable medium which is read from and/or written to by a magnetic, optical, or other reading and/or writing system that is coupled to one or more processors, can be used for the memory 22 in each of the user computing systems 14(1)-14(n).

The user input device 30 in each of the user computing systems 14(1)-14(n) is used to input selections, such as user data including appointments, meetings, and events to interact with applications, although each of the user input devices 30 could be used to input other types of data and interact with other elements. The user input device 30 in each of the user computing systems 14(1)-14(n) comprises a computer keyboard and a computer mouse, although other types and numbers of user input devices 30 can be used for each of the user computing systems 14(1)-14(n).

The display 32 in each of the user computing systems 14(1)-14(n) is used to show data and information to the user, such as a display in real time of reservation options in a calendar application with scheduling conflicts marked, although other types of data and information could be displayed and other manners of providing notification can be used, such as via email, page, SMS, and Web. The display 32 in each of the user computing systems 14(1)-14(n) comprises a computer display screen, such as a CRT or LCD screen by way of example only, although other types and numbers of displays could be used in each of the user computing systems 14(1)-14(n).

The interface system 24 in each of the user computing systems 14(1)-14(n) is used to operatively couple and communicate between each of the user computing systems 14(1)-14(n) and the application provider system 12 and the data provider systems 16(1)-16(n) via communications system 18, although other types and numbers of connections and other configurations and other types of communication systems could be used.

Each of the data provider systems 16(1)-16(n) provides one or more data-driven goods or services, such as airline, train, bus, car rental, taxi, hotel, entertainment, dining, and/or meeting reservations, although one or more of the data provider systems 16(1)-16(n) could provide other types of goods or services and could have other functions and other types and numbers of systems could be used. Each of the data provider systems 16(1)-16(n) includes a central processing unit (CPU) or processor 20, a memory 22, an interface system 24, a database 34, and query software 36 which are coupled together by a bus or other link 28, although one or more of the data provider systems 16(1)-16(n) can comprise other numbers and types of systems, devices, equipment, components, and/or databases in other configurations.

The processor 20 in each of the data provider systems 16(1)-16(n) executes a program of stored instructions for one or more aspects of the present invention as described herein, including scheduling and completing a reservation within an application in real time. The memory 22 stores these programmed instructions for one or more aspects of the present invention as described herein, although some or all of the programmed instructions could be stored and/or executed elsewhere. A variety of different types of memory storage devices, such as a random access memory (RAM), flash memory, or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the management server system. The interface system 24 in each of the data provider systems 16(1)-16(n) is used to operatively couple and communicate between the data provider systems 16(1)-16(n) and the application provider system 12 and user computing systems 14(1)-14(n) via communications system 18, although other types and numbers of connections and other configurations and other types of communication systems could be used. The database 34 stores the list of events, their categories, and the availability of reservation slots at specific dates and times for those events for the query software 36. The query software 36 is the application code that the application server 26 in the application provider system 12 calls to query the database 34. The query software 36 could be an API or the application server could call the database directly.

Although an example of embodiments of the application provider system 12, the user computing systems 14(1)-14(n), and the data provider systems 16(1)-16(n) are described and illustrated herein, each of the application provider system 12, the user computing systems 14(1)-14(n), and the data provider systems 16(1)-16(n) of the present invention could be implemented on any suitable computer system or computing device. It is to be understood that the devices and systems of the exemplary embodiments are for exemplary purposes, as many variations of the specific hardware and software used to implement the exemplary embodiments are possible, as will be appreciated by those skilled in the relevant art(s).

Furthermore, each of the systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the systems in any embodiment of the present invention. Accordingly, principles and advantages of distributed processing, such as redundancy, replication, and the like, also can be implemented, as desired, to increase the robustness and performance of the devices and systems of the exemplary embodiments. The present invention may also be implemented on computer system or systems that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for scheduling and completing a reservation within an application in real time as described herein, which when executed by a processor, cause the processor to carry out the steps necessary to implement the methods of the present invention as described and illustrated herein.

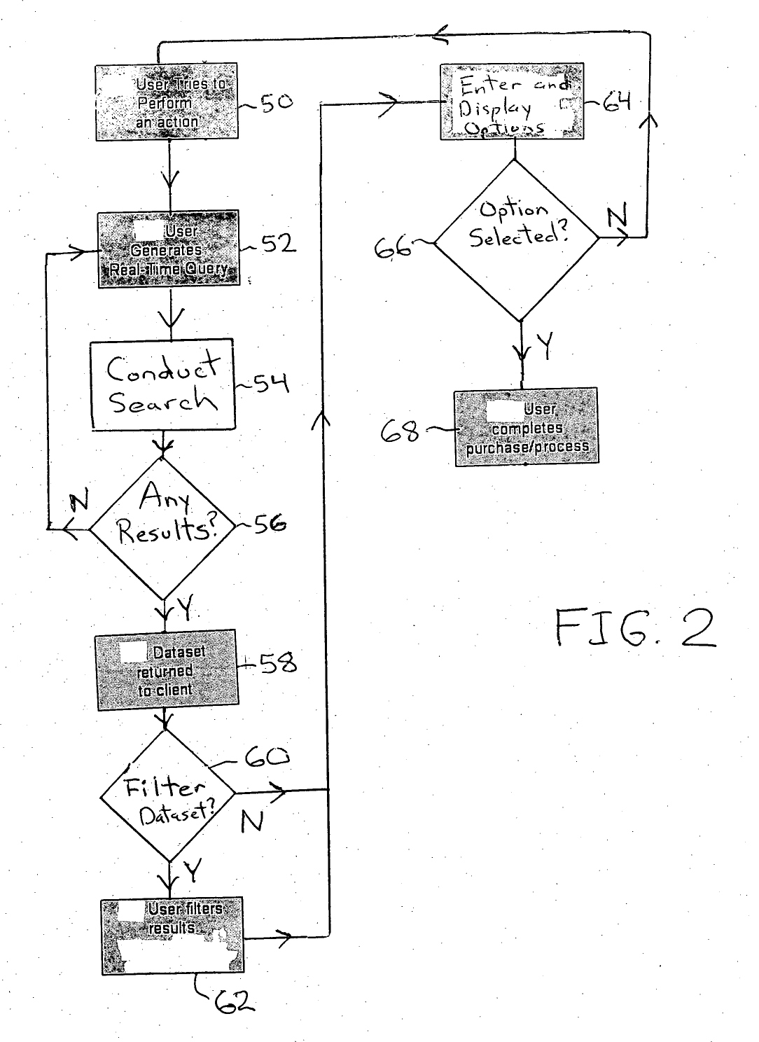

The operation of the system in accordance with embodiments of the present invention will now be described with reference to FIGS. 1, 2, and 3A-3E. In step 50, a user at one of the user computing systems 14(1)-14(n) utilizes an application or applications from the application provider system 12, such as a calendar application, although the application or applications could be obtained from other locations in other manners.

In step 52, the user at the one of the user computing systems 14(1)-14(n) being utilized, activates an enabled link, although other manners for initiating the query between systems or within a system can be used, such as having the user instantiate real-time, asynchronous data exchange by interacting with the dynamic graphical user interface by way of example only. Next, the user creates a real-time query for a reservation option or options while still in the calendar application, although the query can be generated or obtained in other manners at other locations and times. The query includes category criteria, such as categories for airline, train, bus, car rental, taxi, hotel, dining, entertainment, or meeting reservations by way of example only, and date criteria, such as the departure and return dates and times or specific event date or dates, although other types and numbers of criteria could be included in the query. By way of example only, other criteria in the query could be criteria for a particular airline or airlines, car rental agency or agencies and/or hotel or hotels, criteria for the minimum star or other rating for a hotel, restaurant, or show, a particular genre of a cuisine or entertainment, such as comedy or live rock music, or criteria related to proximity to the user location. Once the query is created, the query is transmitted from the one of the user computing systems 14(1)-14(n) being utilized to one or more of the data provider systems 16(1)-16(n) to begin a search for reservation options based on the query. At least a portion of the reservation options being searched for based on the query comprise dynamic data, such as available airline reservation options for departing and returning flights by way of example only.

In step 54, the one or more of the data provider systems 16(1)-16(n) begin a real-time search based on at least the category criteria and date criteria in the query for dynamic reservation option or options, although other system or systems could be used to identify the dynamic reservation option or options which are available. Since systems and methods for searching for dynamic reservation option or options in response to a query, such as a query for airline, train, bus, car rental, taxi, hotel, dining, entertainment, or meeting reservation option or options by way of example only, are well known to those of ordinary skill in the art, those searching systems and methods will not be described in detail here.

In step 56, a determination is made if any dynamic reservation option or options was/were identified. If a relevant dynamic reservation option or options for the query is/are not found or is incomplete, then the No branch is taken to step 52 where the user is prompted to modify and retry the query. If a relevant dynamic reservation option or options to the query is/are identified, then the Yes branch is taken to step 58.

In step 58, the application provider system receives the dynamic reservation option or options from one or more of the data provider systems 16(1)-16(n) and provides the dynamic reservation option or options to the one of the user computing systems 14(1)-14(n) being utilized via the communication system 18. In step 60, the one of the user computing systems 14(1)-14(n) being utilized determines if the dynamic reservation option or options received in step 58 should be filtered. If the received dynamic reservation option or options do not need to be filtered, then the No branch is taken to step 64. If the received dynamic reservation option or options need to be filtered, then the Yes branch is taken to step 62.

In step 62, the one of the user computing systems 14(1)-14(n) being utilized filters the received dynamic reservation option or options based on one or more user input criteria, although the received dynamic reservation option or options can be filtered in other manners. This filtering can be done manually or automatically based on user input criteria at the one of the user computing systems 14(1)-14(n) being utilized. By way of example only, the user input criteria for filtering the received dynamic reservation option or options can comprises at least one of geography, i.e. proximity to the user, genre of event, cost of event, a selection of a minimum rating from a third-party rating system, genre of cuisine, and particular time range.

In step 64, the one of the user computing systems 14(1)-14(n) being utilized enters and displays the initial dynamic reservation option or options or the filtered initial dynamic reservation option or options in the calendar application, although other manners for displaying the dynamic reservation option or options can be used, such as in a table format. By entering each of the dynamic reservations option or options based on their associated date and time in the calendar application, the user is able to see in the display system of the one of the user computing systems 14(1)-14(n) being utilized how the different dynamic reservations option or options correspond with the schedule of the user so that appropriate plans and also any necessary changes to the schedule of the user can be made.

In step 64, the one of the user computing systems 14(1)-14(n) being utilized also provides an indication with each of the dynamic reservations option or options if that dynamic reservation option or options interferes with a previously scheduled appointment in the calendar application of the user. By way of example only, the background color of any dynamic reservation option or options that interferes with a previously scheduled appointment is different from the background color of any dynamic reservation option or options that does not interfere with a previously scheduled appointment, although other types and numbers of designation or markers could be used.

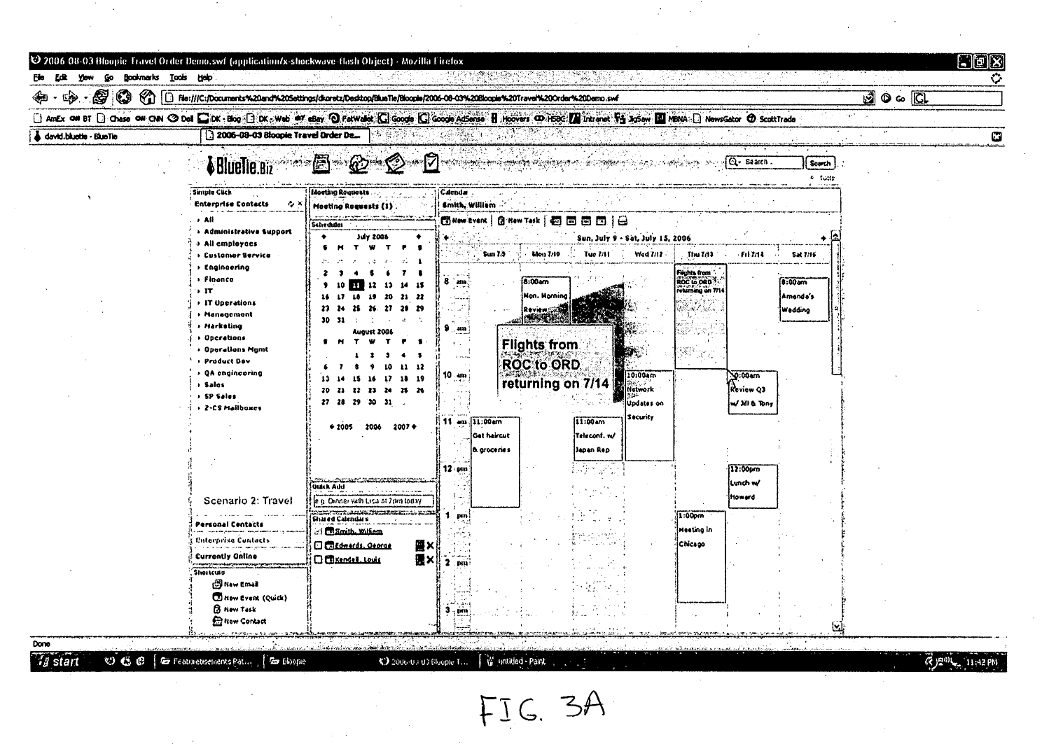

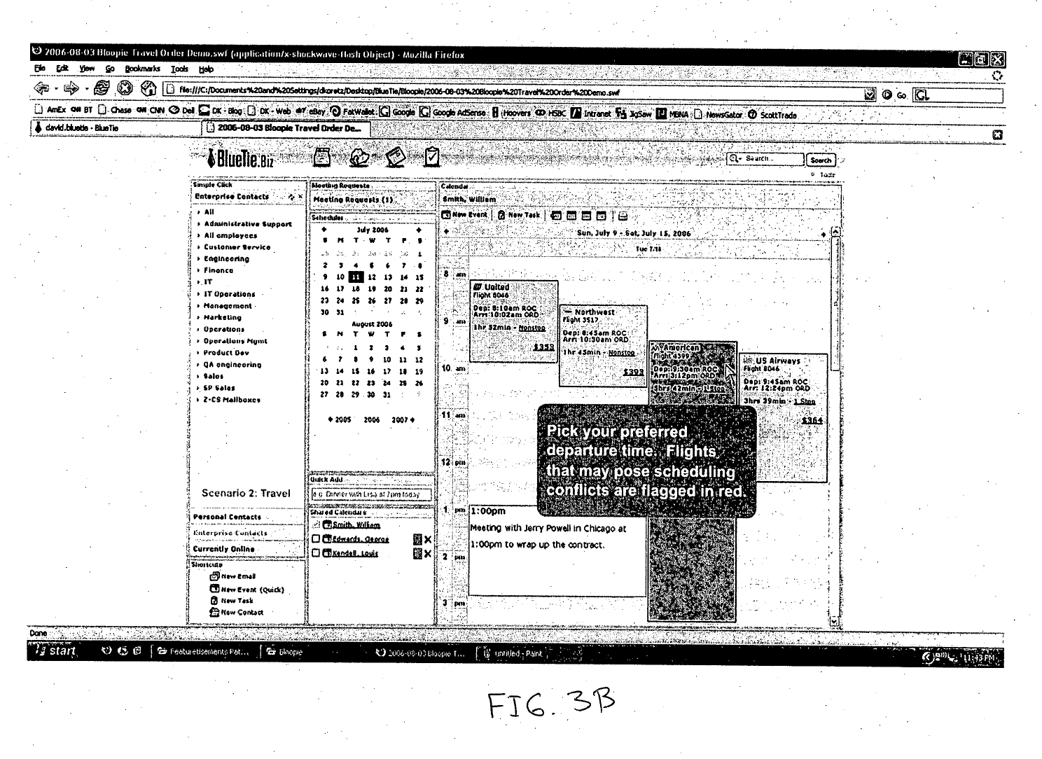

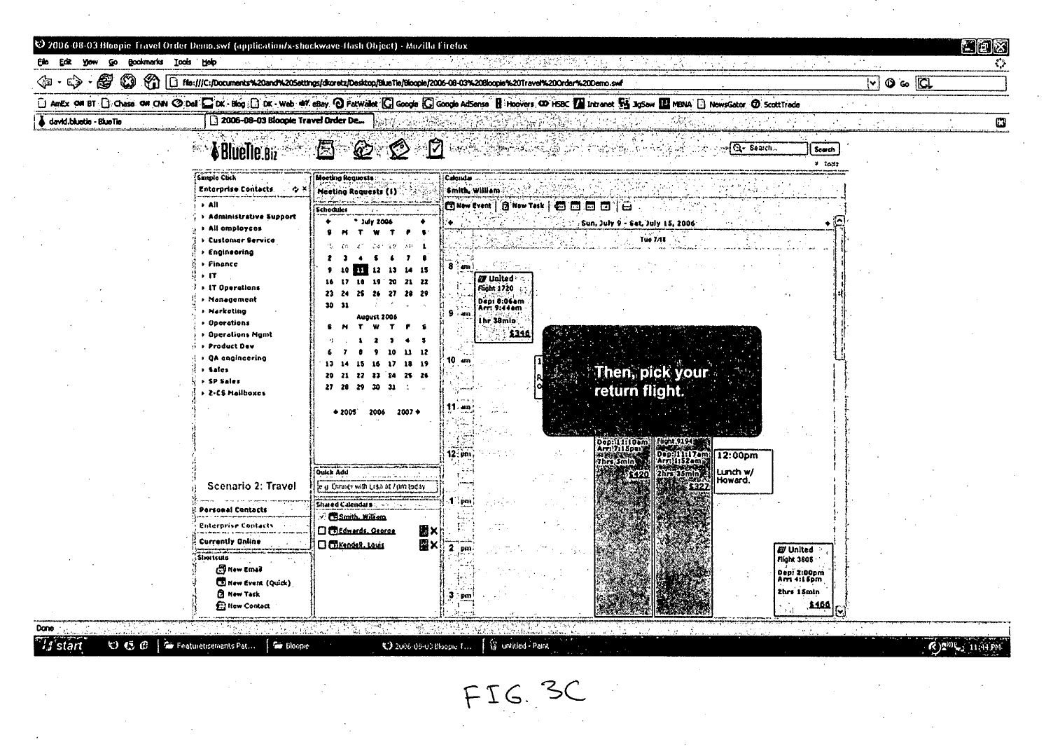

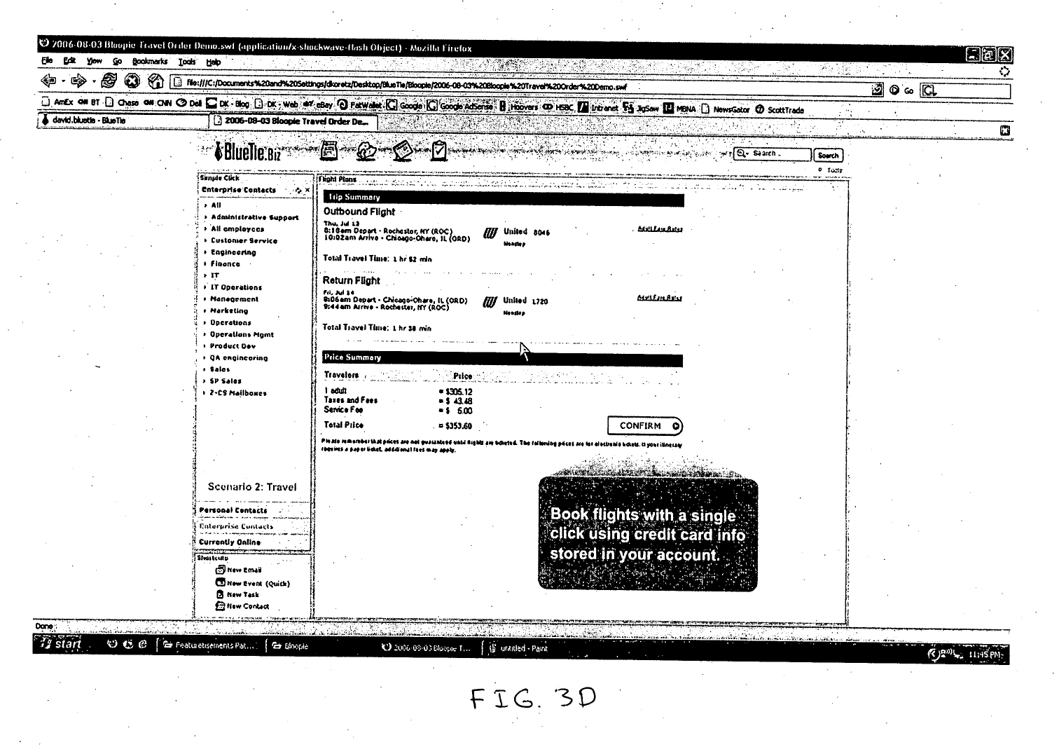

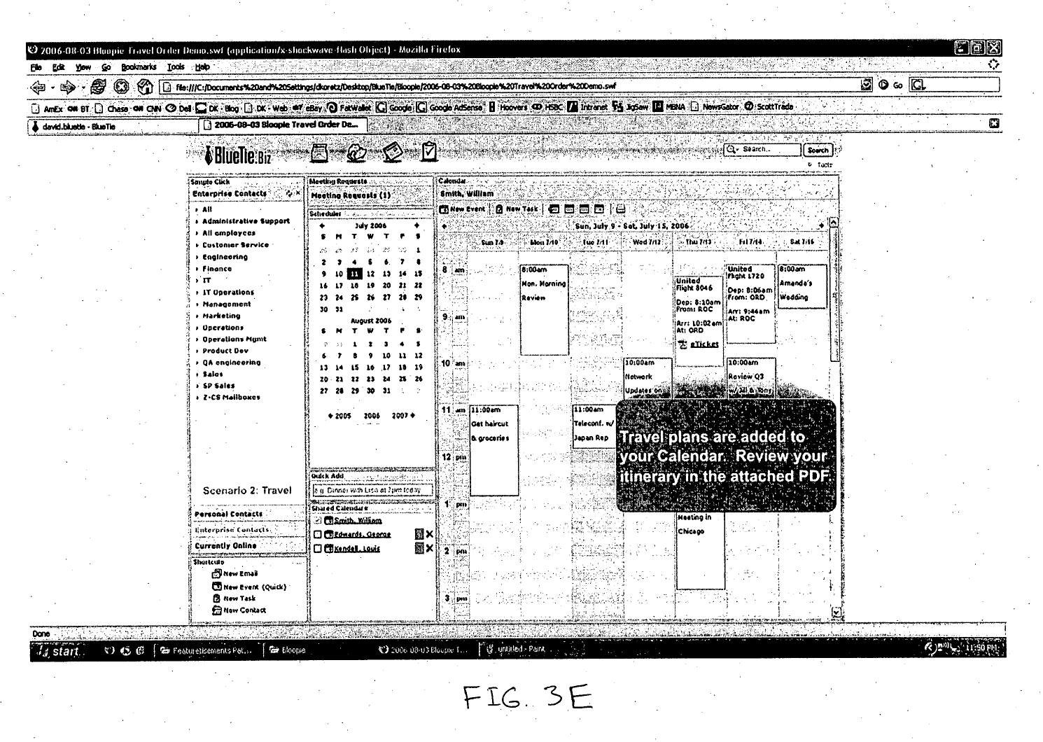

By way of example only, FIGS. 3A-3C illustrate screenshots of departing and returning flight options in response to a query that has been entered in a calendar application. In this example, departing and returning flight options that do not conflict with an existing appointment in the calendar application have a blue background while departing and returning flight options that pose a conflict have a pink background, although other colors or indicators could be used.

In step 66, the one of the user computing systems 14(1)-14(n) being utilized determines if an enabled link or links for the displayed reservation option or options, has/have been selected. If the one or more of the reservation options in the calendar application have not been selected, then after a set period of time the No branch is taken back to step 50 as described earlier, although other manners for providing an indication that none of the reservation options have been selected could be used. By way of example only, the user could enter an input into the one of the user computing systems 14(1)-14(n) being utilized that declines the reservation options. When none of the reservation options have been selected, then the one of the user computing systems 14(1)-14(n) being utilized removes the reservation options from the calendar application. If one or more of the reservation options in the calendar application have been selected, then the Yes branch is taken to step 68.

In step 68, the selected reservation option or options are entered in the calendar application and the unselected reservation option or options are removed from the calendar application in the one of the user computing systems 14(1)-14(n) being utilized. In step 68, the user at the one of the user computing systems 14(1)-14(n) being utilized can complete the purchase transaction for the selected reservation option or options without leaving the calendar application. By way of example only, screenshots of the selection and purchase of departing and return flight options and the entry of the purchased of departing and return flights in the calendar application is illustrated in FIGS. 3B-3E.

Accordingly, the present invention provides a number of advantages including providing an effective and automatic system and method for users of a Web-based or client-server software application or other application to complete real-time reservations, including ticketing, while in an application. Additionally, as illustrated herein the present invention is versatile and easily can be used for a wide range of reservation processes, including, but not limited to airline, train, bus, car rental, taxi, hotel, entertainment, dining, and/or meeting reservations.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for scheduling and completing a reservation, the method comprising:
receiving at least one query for a dynamic event, the query comprising category criteria and date criteria;
identifying a dynamic set of one or more options in real time which satisfy at least the category criteria and the date criteria in the query; and
entering and displaying in real time each of the identified dynamic options.

2. The method as set forth in claim 1 further comprising:
receiving in real time a selection of at least one of the displayed dynamic options; and
completing a reservation of the received selection of one of the displayed dynamic options.

3. The method as set forth in claim 2 wherein the entering and displaying further comprises entering and displaying in real time each of the identified dynamic options in a calendar application.

4. The method as set forth in claim 3 further comprising removing the other displayed dynamic options from the calendar application which were not selected.

5. The method as set forth in claim 1 further comprising filtering the identified dynamic options based on one or more user input criteria, wherein the entering further comprises entering and displaying in real time each of the identified and filtered dynamic options.

6. The method as set forth in claim 5 wherein the user input criteria comprises at least one of geography range, genre of event, cost of event, a third-party rating system, genre of cuisine, and time range.

7. The method as set forth in claim 1 wherein the entering and displaying further comprises entering and displaying in real time each of the identified dynamic options in a calendar application and further comprises providing an indication for each of the entered dynamic options that interfere with one or more appointments in the calendar application.

8. The method as set forth in claim 7 wherein the indication comprises a different background color for the entered dynamic options that interferes with one or more appointments in the calendar application.

9. The method as set forth in claim 1 wherein completing a reservation further comprises completing a purchase of the received selection of one of the displayed dynamic options.

10. The method as set forth in claim 1 wherein the category criteria comprises at least one of an airline reservation, a train reservation, a bus reservation, a car rental reservation, a taxi reservation, and a hotel reservation and the date criteria comprises at least one of a departure date and a return date.

11. The method as set forth in claim 1 wherein the category criteria comprises at least one of an entertainment event and a dining event and the date criteria comprises one or more selected dates.

12. A computer readable medium having stored thereon instructions for scheduling and completing a reservation comprising machine executable code which when executed by at least one processor, causes the processor to perform steps comprising:
receiving at least one query for a dynamic event, the query comprising category criteria and date criteria;
identifying a dynamic set of one or more options in real time which satisfy at least the category criteria and the date criteria in the query; and
entering and displaying in real time each of the identified dynamic options.

13. The medium as set forth in claim 12 further comprising:
receiving in real time a selection of at least one of the displayed dynamic options; and
completing a reservation of the received selection of one of the displayed dynamic options.

14. The method as set forth in claim 13 wherein the entering and displaying further comprises entering and displaying in real time each of the identified dynamic options in a calendar application.

15. The method as set forth in claim 14 further comprising removing the other displayed dynamic options from the calendar application which were not selected.

16. The medium as set forth in claim 12 further comprising filtering the identified dynamic options based on one or more user input criteria, wherein the entering further comprises entering and displaying in real time each of the identified and filtered dynamic options in the calendar application.

17. The medium as set forth in claim 16 wherein the user input criteria comprises at least one of geography range, genre of event, cost of event, a third-party rating system, genre of cuisine, and time range.

18. The medium as set forth in claim 12 wherein the entering and displaying further comprises entering and displaying in real time each of the identified dynamic options in a calendar application and further comprising providing an indication for each of the entered dynamic options that interfere with one or more appointments in the calendar application.

19. The medium as set forth in claim 18 wherein the indication comprises a different background color for the entered dynamic options that interferes with one or more appointments in the calendar application.

20. The medium as set forth in claim 12 wherein completing a reservation further comprises completing a purchase of the received selection of one of the displayed dynamic options.

21. The medium as set forth in claim 12 wherein the category criteria comprises at least one of an airline reservation, a train reservation, a bus reservation, a car rental reservation, a taxi reservation, and a hotel reservation and the date criteria comprises at least one of a departure date and a return date.

22. The medium as set forth in claim 12 wherein the category criteria comprises at least one of an entertainment event and a dining event and the date criteria comprises one or more selected dates.

23. A reservation system, the system comprising:
a communication system that receives at least one query for a dynamic event, the query comprising category criteria and date criteria;
a search system that identifies a dynamic set of one or more options in real time which satisfy at least the category criteria and the date criteria in the query; and
a display processing system that enters and displays in real time each of the identified dynamic options.
a transaction system that completes a reservation of a selection of at least one of the displayed dynamic options received from the communication system.

24. The system as set forth in claim 23 further comprising a transaction processing system that receives in real time a selection of at least one of the displayed dynamic options and completes a reservation of the received selection of one of the displayed dynamic options.

25. The system as set forth in claim 24 wherein the display processing system enters and displays in real time each of the identified dynamic options in a calendar application.

26. The method as set forth in claim 25 wherein the display processing system removes the other displayed dynamic options from the calendar application which were not selected.

27. The system as set forth in claim 23 further comprising a filtering system that filters the identified dynamic options based on one or more user input criteria, wherein the display processing system enters and displays in real time each of the identified and filtered dynamic options.

28. The system as set forth in claim 27 wherein the user input criteria comprises at least one of geography range, genre of event, cost of event, a third-party rating system, genre of cuisine, and time range.

29. The system as set forth in claim 23 wherein the display processing system enters and displays in real time each of the identified dynamic options in a calendar application and provides an indication for each of the entered dynamic options that interfere with one or more appointments in the calendar application.

30. The system as set forth in claim 29 wherein the indication comprises a different background color for the entered dynamic options that interferes with one or more appointments in the calendar application.

31. The system as set forth in claim 23 wherein the transaction system completes a purchase of the received selection of one of the displayed dynamic options.

32. The system as set forth in claim 23 wherein the category criteria comprises at least one of an airline reservation, a train reservation, a bus reservation, a car rental reservation, a taxi reservation, and a hotel reservation and the date criteria comprises at least one of a departure date and a return date.

33. The system as set forth in claim 23 wherein the category criteria comprises at least one of an entertainment event and a dining event and the date criteria comprises one or more selected dates.
